(19) United States
(12) Patent Application Publication
(10) Pub. No.: US 2013/0080246 A1
(43) Pub. Date: Mar. 28, 2013

(54) E-COMMERCE MARKETPLACE OPTIMIZATION SYSTEMS AND METHODS

(71) Applicant: Sheldon Gilbert, New York, NY (US)

(72) Inventor: Sheldon Gilbert, New York, NY (US)

(21) Appl. No.: 13/628,799

(22) Filed: Sep. 27, 2012

Related U.S. Application Data
(60) Provisional application No. 61/539,968, filed on Sep. 27, 2011.

(51) Int. Cl. G06Q 30/02

(52) U.S. Cl. 705/14.45; 705/14.66; 705/14.71

(57) ABSTRACT

Systems, methods, and computer program products for: facilitating a business-to-business (“B2B”) consumer acquisition marketplace among several online and offline advertisers to acquire customers in either a spot or futures market in any addressable media; optimizing use of real-time bidding to retain and acquire opportunities to access customers via any addressable media; optimizing the attribution of credit and payment to advertisers (or their service providers on their behalf) serving advertisements in any addressable media; and facilitating a business-to-consumer (“B2C”) marketplace that leverages consumer valuations to enable to enable consumers to optimize buying decisions as they engage with advertisers in the B2C marketplace are disclosed. In an aspect, such consumer acquisition marketplace analyzes consumer behavior data and advertiser data in order to generate a valuation score indicative of the value of a consumer to one of a plurality of advertisers.

### CROSS REFERENCE TO RELATED APPLICATIONS

This application claims priority to U.S. Provisional Patent Application No. 61/539,968, filed Sep. 27, 2011, and entitled “E-Commerce Marketplace Optimization Systems and Methods,” which is hereby incorporated by reference in its entirety.

This application is related to U.S. Pat. No. 8,027,864, issued on Sep. 27, 2011; U.S. Pat. No. 8,027,865, issued on Sep. 27, 2011; and U.S. Pat. No. 8,032,405, issued on Oct. 4, 2011 (collectively, the “Gilbert Patents”). Each Gilbert Patent was issued to Sheldon Gilbert and is hereby incorporated by reference in its entirety. The Gilbert Patents each claimed priority to U.S. Provisional Application Ser. No. 60/860,560, filed on Nov. 22, 2006, which also is hereby incorporated by reference in its entirety.

### BACKGROUND OF THE INVENTION

1. Field of the Invention

The present invention generally relates to consumer-based behavioral target marketing, and more particularly to systems, methods and computer program products for facilitating online and offline marketing and the placement of advertising in any addressable media (e.g., online display, mobile display, such as phone or tablet inventory, television, dynamic catalogs or dynamic billboards, and the like).

2. Related Art

The Gilbert Patents (Each entitled “System and Method for Providing E-Commerce Consumer-Based Behavioral Target Marketing Reports”) addressed the problem of offering relevant products to attract and retain online consumers effectively, given the ever increasing number of competitors emerging on the Internet. That is, as consumers are faced with an overwhelming selection of products, content, and/or online services, companies are faced with an equal level of decision complexity in order to effectively determine which of their ever expansive inventory of products should be offered to a consumer population, the vast majority of which are anonymous visitors of their online stores. The lack of visibility into the interests and shopping preferences of a large and often heterogeneous consumer base led to suboptimal marketing and merchandising strategies as a result of undifferentiated product offerings.

To meet the above-identified needs in the art, the Gilbert Patents disclosed system, methods, and computer program products which enabled users to model end consumer interests in items based on exhibited shopping activity online in order to predict purchasing patterns. That is, the Gilbert Patents were concerned with retention marketing so as to increase order conversion rates and profit margins of marketing campaigns and promotions by determining the right products to offer to the right customers at the right time. Such systems, methods and computer program products, however, mostly related to a single online advertiser engaging in directed marketing to its own existing customers or potential customers with which such advertisers had pre-existing contact.

Given the foregoing, what are needed are systems, methods and computer program products for facilitating the online and offline marketing and placement of advertising in any addressable media (e.g., online display, mobile display, such as phone or tablet inventory, television, dynamic catalogs or dynamic billboards, and the like), in a manner that leverages the calculation of consumer valuation, real-time bidding optimization, and attribution optimization to facilitate business-to-business (“B2B”) and business-to-consumer (“B2C”) transactions.

### BRIEF DESCRIPTION OF THE DRAWINGS

The features and advantages of the present invention will become more apparent from the Detailed Description set forth below when taken in conjunction with the drawings in which like reference numbers indicate identical or functionally similar elements.

FIG. 1 is a high-level block diagram illustrating a system for implementing various aspects of the present invention.

FIGS. 2-7 are flowcharts of exemplary processes according to various aspects of the present invention.

FIG. 8 is a block diagram of an exemplary computer system useful for implementing the present invention.

### DETAILED DESCRIPTION

The present invention meets the above-identified needs by providing systems, methods and computer program products for: (A) facilitating a business-to-business (“B2B”) consumer acquisition marketplace among several online and offline advertisers to acquire customers in either a spot or futures market in any addressable media; (B) optimizing the use of real-time bidding to retain and acquire opportunities to access customers via any addressable media; (C) optimizing the attribution of credit and payment to advertisers (or their service providers on their behalf) serving advertisements in any addressable media; and (D) facilitating a business-to-consumer (“B2C”) marketplace that leverages consumer valuations to enable to enable consumers to optimize buying decisions as they engage with advertisers in the B2C marketplace.

### A. B2B Consumer Acquisition Marketplace

In the past, advertisers have attempted to create a consumer acquisition marketplace via customer or data cooperative exchanges or “CO-OPS.” Advertisers participating in CO-OPs would contribute their customer information to enable access by other CO-OP participants in exchange for the opportunity to target the customers of other participating members in order to acquire new customers. But a significant limitation of this approach is that CO-OPs provide these opportunities to advertisers in a pricing and access structure that assumes each customer acquisition opportunity has an equal value and does not provide a means to price the opportunity to target those customers for acquisition based on each consumer's economic value to the advertiser.

As will be appreciated by those skilled in the relevant art(s) after reading the description herein, in contrast, the present invention solves this dilemma by: (1) giving advertisers a means to access a calculation of the value of each potential customer in relation to their businesses, as a basis not only to decide whether to acquire a customer, but also to determine how much they should pay for the opportunity to do so; and (2) providing an environment that creates and facilitates the opportunity to engage in those transactions. In effect, the present invention provides a means of securitizing the opportunity for marketplace participants to evaluate and purchase.

In an aspect of the present invention, a service provider establishes a framework that creates opportunities for advertisers to target potential customers for acquisition. Such a service provider, via a plurality of service agreements, has access to each advertiser's clickstream, online and/or offline transactions, merchandise and customer data. In such an aspect, the service provider may use the analysis of clickstream data, online and/or offline transactions, and merchandise and customer data to calculate “valuation scores” for each of a plurality of potential (e.g., 100) customers in relation to several advertisers, and for each advertiser, in relation to a range of that advertiser's merchandise available for sale (e.g., each customer will have separate valuation scores in relation to products X1, X2 and X3 sold by advertiser X, and also in relation to products Y1, Y2 and Y3 sold by advertiser Y). Thus, rather than target all 100 of the customers with the same advertisement, each advertiser is enabled by the service provider to use the valuation scores to optimize multiple, simultaneous campaigns, with the valuation scores determining which product advertisement a customer receives (e.g., customer A with a high valuation score for a shoe product will receive a shoe advertisement, while customer B with a high valuation score for jackets, will receive advertisements related to jackets).

Each advertiser may also use the valuation scores to determine with which advertising channel or medium to target potential customers. For example, an advertiser may choose to target potential customers with high valuation scores using direct mail (e.g., postal mailing a catalog), target potential customers with high- or middle-valuation scores with display or email, and/or not to target potential customers with low value scores.

In this aspect of the present invention, a first advertiser may choose to offer the opportunity to target customers with low valuation scores to another, second advertiser who is also a client of the service provider utilizing the present invention. In such an aspect, those potential customers would have a higher valuation score relative to the second advertiser than they did relative to the first advertiser. This creates a marketplace among advertisers for potential customers to target using different marketing campaigns.

To illustrate the above aspect, the service provider may calculate that potential customer X has a valuation score of $1.00 relative to advertiser 1. The service provider, however, may calculate that potential customer X also has a valuation score of $4.00 relative to advertiser 2. In such a marketplace created by the service provider implementing the present invention, advertiser 2 may want to pay advertiser 1 a fee (presumably less than $4) for the opportunity to target an advertisement to customer X.

As will be appreciated by those skilled in the relevant art(s) after reading the description herein, as the service provider has n number of advertisers offering m number of products/services, this creates a [n]×[m]×[total number of n advertisers' customers] consumer marketplace for potential customers to target using different marketing campaigns.

In an aspect of the present invention, the service provider may determine causal relationships based on the dynamics between data sets contributed by each marketplace participant about its customers. The service provider can determine valuation scores not only based on a specific advertiser's customer information, but can also analyze customer data sets across multiple advertisers participating in the marketplace in order to determine causal relationships and to develop and refine valuation scores of consumers in relation to all of the other marketplace participants and their products. The service provider may also assess which data sets contributed to this additional development and refinement of valuation scores and to what extent incrementally. The service provider may then offer a marketplace participant acquisition opportunities, with payments to the other participants based on their incremental contributions to determining the causal relationship. For example, advertisers 1, 2, 3, and 4 participate in a service provider's marketplace. The service provider determines, based on data contributed by 2, 3, and 4, that customer X has a valuation score of $500 in relation to advertiser 1's products, with advertiser 2 contributing 25% to computation of the score, and with 3 and 4 contributing 40% and 35% respectively. The service provider may then give marketplace credits or fees to advertisers, with 2, 3 and 4 receiving 25%, 40% and 35% of the credits or fees, respectively.

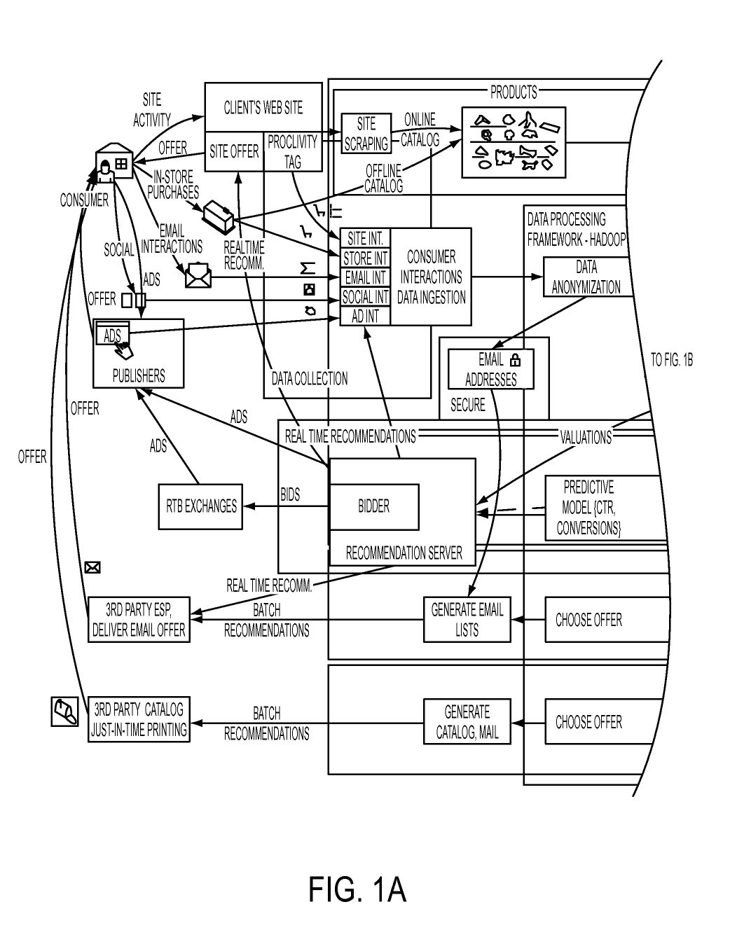

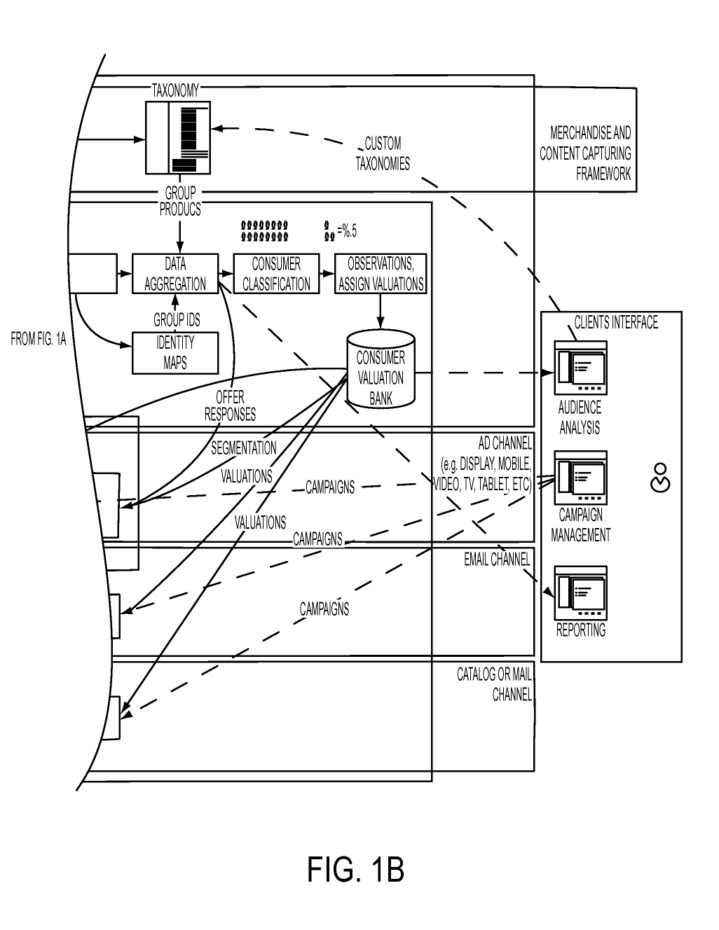

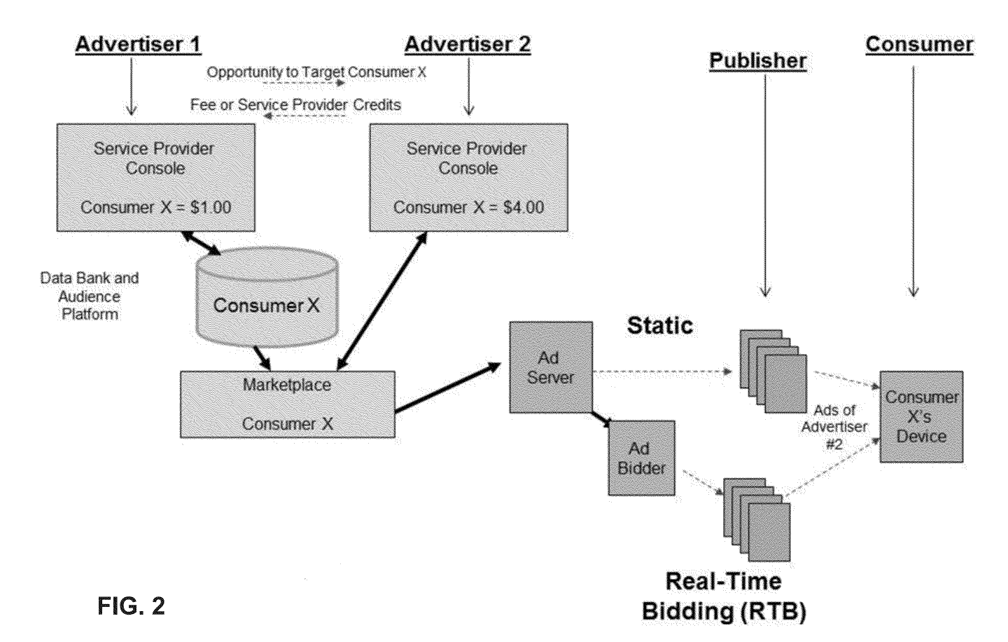

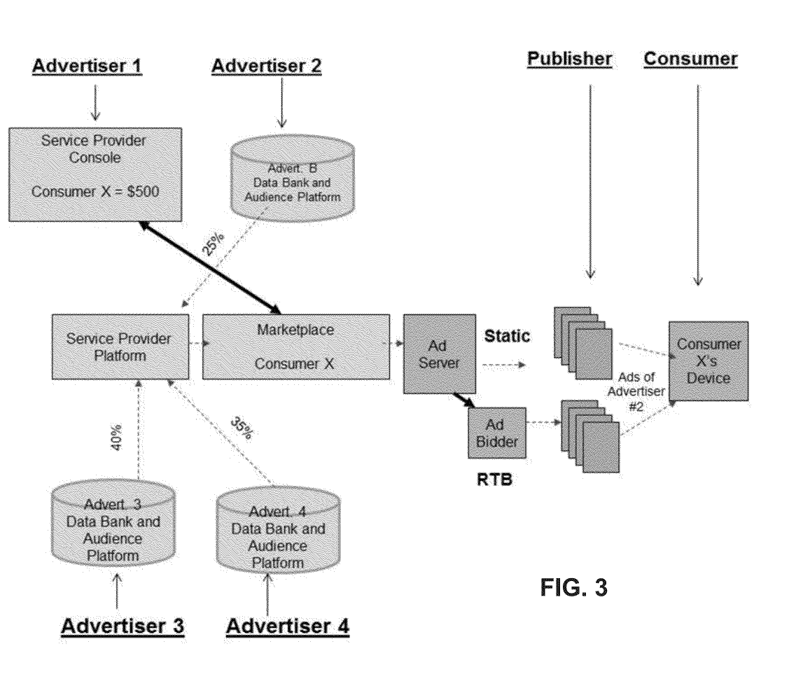

A system diagram in which the service provider may allow access, on a free registration, paid subscriber and/or pay-per-use basis, to the infrastructure implementing the above-described B2B consumer acquisition marketplace via, for example, one or more World-Wide Web (WWW) sites on the Internet is shown in FIG. 1 and the implementing method steps are shown in the flowcharts of FIG. 2 and FIG. 3.

As will be appreciated by those skilled in the relevant art(s) after reading the description herein, the present invention may be used not only by advertisers targeting prospective customers, but also by charitable organizations targeting donors, political candidates targeting potential voters, educational institutions targeting prospective students and the like.

### B. Real-Time Bidding Optimization

In an aspect of the present invention, the above-described process may be implemented not only to create a marketplace for consumers among advertisers, but also to optimize how those advertisers and their service providers purchase addressable media to show advertisements to those consumers, and in particular, manage risk and bidding strategies, when such media is offered via an auction model.

Advertisers and their service providers participate in auctions to purchase media inventory from entities that have consolidated such inventory in order to have the opportunity to show advertisements to consumers viewing such media. Currently, those participants compute the bids they offer based on the nature of the media, audience identity, time and assumptions about the price necessary to win the bid. But those participants currently do not have a means to integrate a consumer's economic value as part of that computation in order to price those bids optimally. As a result, participants may overbid or underbid for the opportunity to show advertisements to a user.

Thus, the present invention provides a means for advertisers and their service providers to use a consumer's economic value to determine bidding strategy and pricing. To illustrate the above aspect, service provider A may engage a relationship with a media provider in order to bid on the opportunity to show an advertisement to a consumer. In addition, service providers B, C, and D may also engage in a similar relationship with the media provider. The media provider's server may call the bidding servers or bidders of service providers A, B, C and D, inviting those service providers to bid on the opportunity to show an advertisement to consumer X. Service providers B, C and D bid $2, $2.75 and $4.00, respectively. Service provider A, with the knowledge that consumer X has a present value of $400 to Advertiser 1, bids $200 and wins the bid (with the bid settlement determined by the auction model) and acquires the opportunity to show advertisements to that customer, creating a framework to resell that opportunity to Advertiser 1 based on the spread, resulting in an economic benefit for both Service Provider A and the advertiser.

In another aspect of the present invention (and as an extension of this example), the service provider, with the knowledge that Customer X will be worth $1000 to Advertiser 2 in the future, can facilitate the opportunity for Advertiser 1 to resell that opportunity to Advertiser 2 for future targeting, with the service provider receiving a fee or credits.

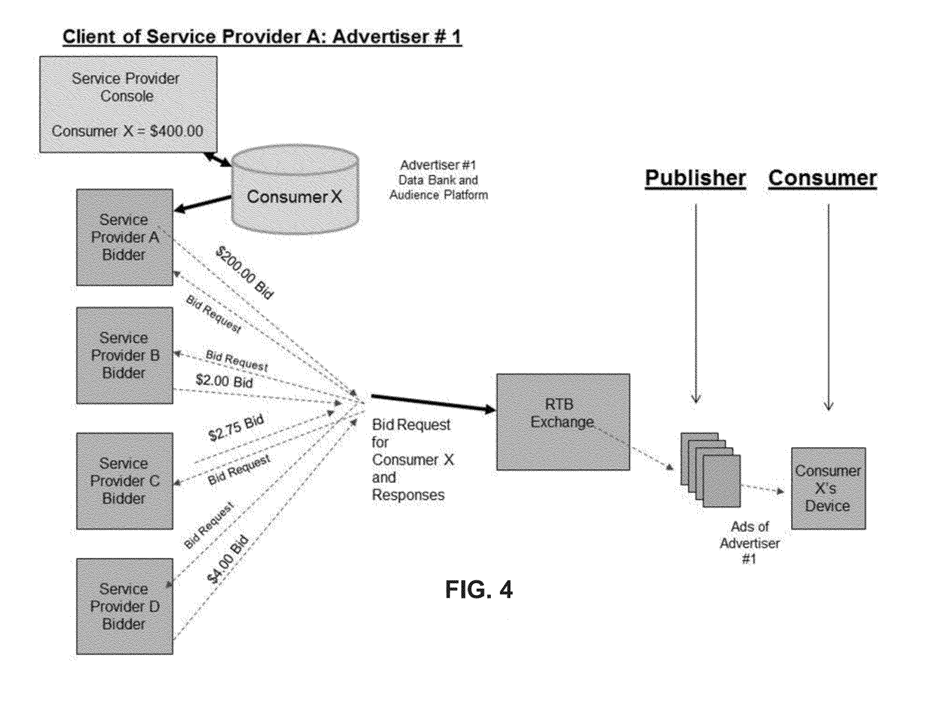

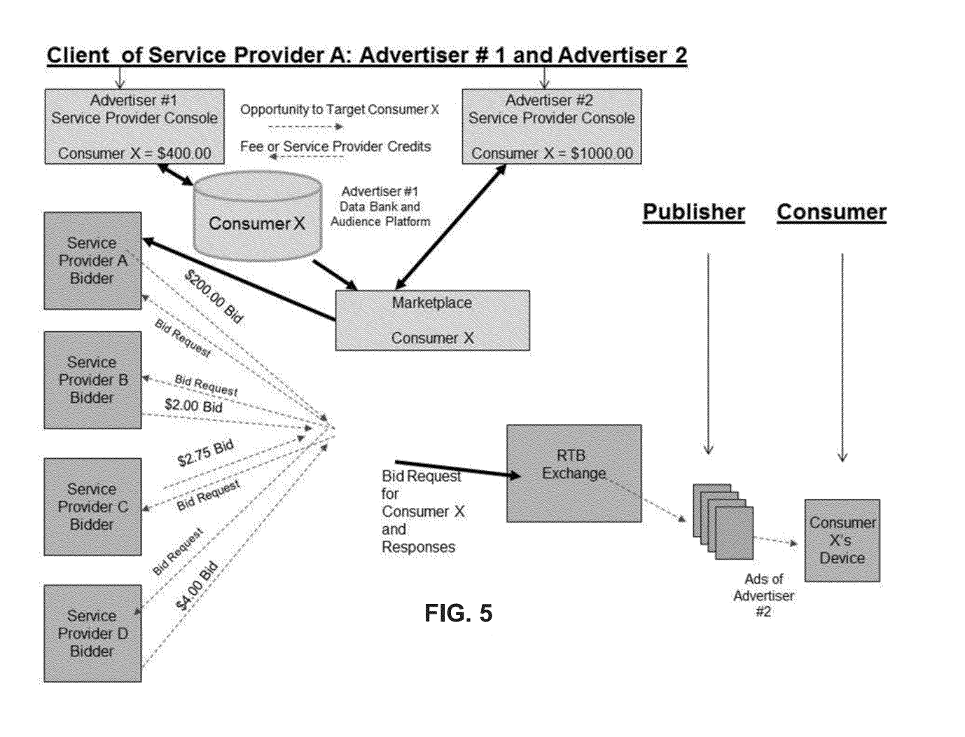

The implementing method steps are shown in the flowcharts of FIGS. 4 and 5.

### C. Optimizing Attribution for Serving Advertisements

In an aspect of the present invention, advertisers and their service providers can use the system to determine how much payment a service provider should receive in exchange for showing advertisements to customers on behalf of its advertiser client. Advertisers and their service providers currently use certain attribution methodologies to determine whether showing an advertisement to a consumer resulted in a transaction (e.g., purchasing a good or donating to a cause). Two common forms of attribution are: “click-through attribution” (which may credit an entity showing an advertisement when a consumer clicks on an advertisement and subsequently completes a transaction); and “view-through attribution” (which may credit an entity when a consumer views an advertisement shown by that entity and subsequently completes a transaction).

The industry currently utilizes several attribution timeframes or “attribution windows” to set a time period after an advertisement is shown to a consumer or consumer interacted with the advertisement, during which transactions completed by that consumer will be attributable to the service provider showing the advertisement to that consumer. Currently, there is no mechanism for determining the correct time period. As a result, industry standards vary, such as 0 view-through attribution to 14-day view-through attribution, and 7-day click-through attribution to 30-day click-through attribution.

The present invention provides a mechanism to set the timeframe during which to attribute transactional activity to an advertiser or service provider. The system determines the optimal attribution timeframes by measuring and comparing the transaction activity of two sets of equally-sized populations, each with equal economic valuations to a particular advertiser during an established testing period. During the testing period, the system shows one group an advertisement, but does not show the advertisement to the other group. Based on analysis of the comparative levels of transactional activity by the two groups over the testing period, the system can compute the point in time prior to which showing the advertisement led to transactional activity, and similarly the point after which showing an advertisement ceased to correlate strongly with transactional activity. The system can further analyze and dissect consumer responses to advertisements for varying types of products to identify and correlate product-specific attribution windows (e.g. the system may determine that the attribution window for apparel should be 30 days, but 60 days for furniture).

To illustrate the above aspect, a service provider may run a campaign for a client for 60 days, showing advertisements to the client's customers with sufficiently high valuation scores. The service provider carves out two groups from the broader campaign. Each group is composed of customers with valuation scores of $50 in relation to the campaign. Over the 60 days, the service provider does not show the advertisement to Group A, but shows the advertisement to Group B. The service provider then measures and graphs the transactional activity of both groups, identifying the points and timeframes where the activity levels of group A and group B meet, thereby creating a basis for using that timeframe as the demarcation, prior to which the service provider should receive credit for transactional activity related to showing the advertisements.

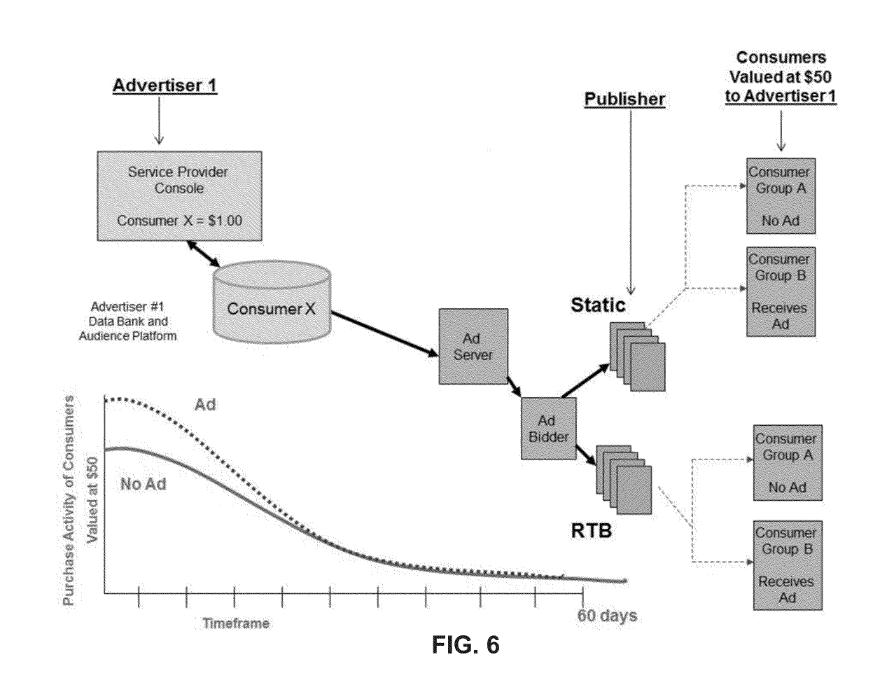

The implementing method steps are shown in the flowchart of FIG. 6.

### D. Creating B2C Marketplace

In an aspect of the present invention, the service provider may communicate to consumers the “valuation score” it calculates for that consumer relative to an advertiser or advertisers' product or service, allowing the consumer to make decisions about engagement with that entity. Consumers have choices as to which advertisers, nonprofits and other entities to engage for products and services, and share information. Currently, consumers base their decisions in part on assumptions about how well they are valued by those entities as indicated by a variety of factors, such as level and quality of service, pricing and discount options offered and other similar information. But consumers have very little insight into their actual economic value to those entities and even less about how their value to a particular entity compares with their value to another entity. Thus, the present invention provides a way for consumers to have insight into their own economic value to entities in the marketplace and use that information to decide whether to engage with those entities and under what terms.

To illustrate the above aspect, a service provider may communicate to a consumer that she has a valuation score of $100.00 relative to advertiser 1, but a valuation score of $200 relative to advertiser 2. In that instance, the consumer when armed with this knowledge can use this information to condition engagement with advertiser 2 on the ability to access more benefits and services in correlation to their higher valuation to advertiser 2.

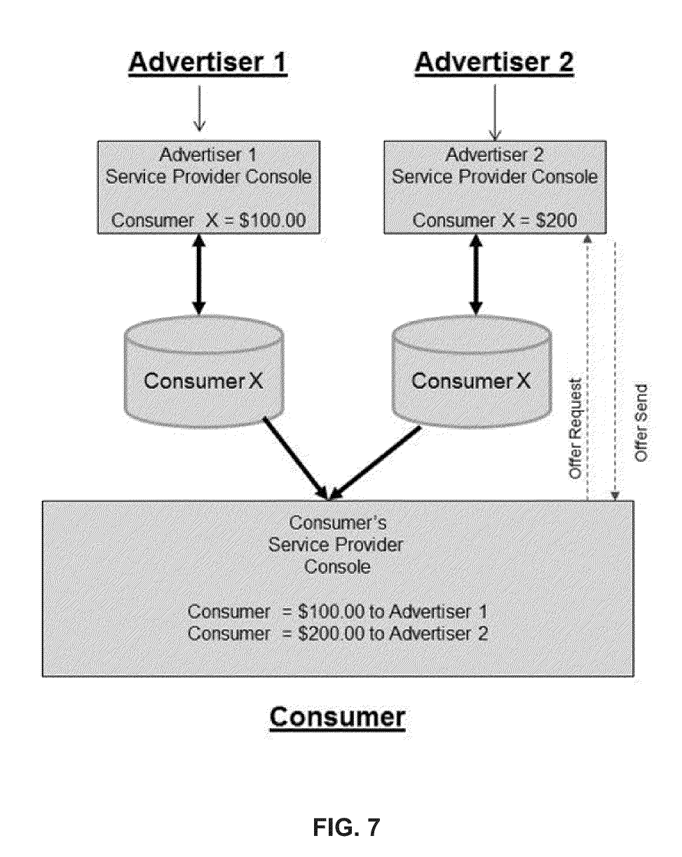

The implementing method steps are shown in the flowchart of FIG. 7.

### Example Environment

The present invention (i.e., system 100, flows 200-700, or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

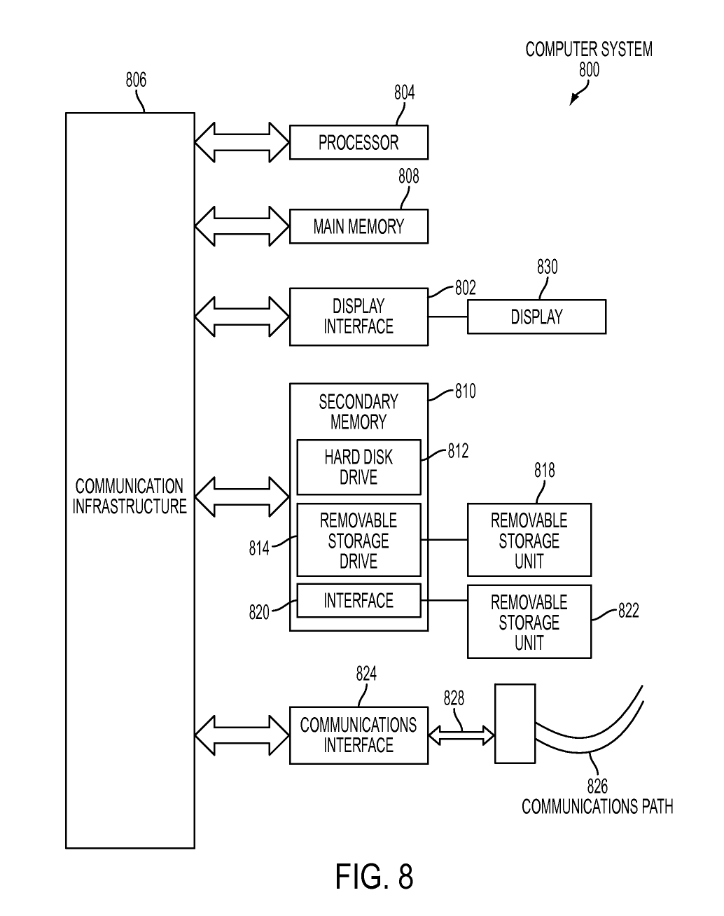

In fact, in one aspect, the invention is directed toward one or more computer systems capable of carrying out the functionality described herein. An example of a computer system 800 is shown in FIG. 8.

The computer system 800 includes one or more processors, such as processor 804. The processor 804 is connected to a communication infrastructure 806 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 800 can include a display interface 802 that forwards graphics, text and other data from the communication infrastructure 806 (or from a frame buffer not shown) for display on the display unit 830.

Computer system 800 also includes a main memory 808, preferably random access memory (RAM) and may also include a secondary memory 810. The secondary memory 810 may include, for example, a hard disk drive 812 and/or a removable storage drive 814, representing a floppy disk drive, a magnetic tape drive, an optical disk drive, etc. The removable storage drive 814 reads from and/or writes to a removable storage unit 818 in a well known manner. Removable storage unit 818 represents a floppy disk, magnetic tape, optical disk, etc. which is read by and written to by removable storage drive 814. As will be appreciated, the removable storage unit 818 includes a computer usable storage medium having stored therein computer software and/or data.

In alternative aspects, secondary memory 810 may include other similar devices for allowing computer programs or other instructions to be loaded into computer system 800. Such devices may include, for example, a removable storage unit 822 and an interface 820. Examples of such may include a program cartridge and cartridge interface (such as that found in video game devices), a removable memory chip (such as an erasable programmable read only memory (EPROM), or programmable read only memory (PROM)) and associated socket and other removable storage units 822 and interfaces 820, which allow software and data to be transferred from the removable storage unit 822 to computer system 800.

Computer system 800 may also include a communications interface 824. Communications interface 824 allows software and data to be transferred between computer system 800 and external devices. Examples of communications interface 824 may include a modem, a network interface (such as an Ethernet card), a communications port, a Personal Computer Memory Card International Association (PCMCIA) slot and card, etc. Software and data transferred via communications interface 824 are in the form of non-transitory signals 828 which may be electronic, electromagnetic, optical or other signals capable of being received by communications interface 824. These signals 828 are provided to communications interface 824 via a communications path (e.g., channel) 826. This channel 826 carries signals 828 and may be implemented using wire or cable, fiber optics, a telephone line, a cellular link, an radio frequency (RF) link and other communications channels.

In this document, the terms “computer program medium” and “computer usable medium” are used to generally refer to non-transitory media such as removable storage drive 814, a hard disk installed in hard disk drive 812 and signals 828. These computer program products provide software to computer system 800. The invention is directed to such computer program products.

Computer programs (also referred to as computer control logic) are stored in main memory 808 and/or secondary memory 810. Computer programs may also be received via communications interface 824. Such computer programs, when executed, enable the computer system 800 to perform the features of the present invention, as discussed herein. In particular, the computer programs, when executed, enable the processor 804 to perform the features of the present invention. Accordingly, such computer programs represent controllers of the computer system 800.

In an aspect where the invention is implemented using software, the software may be stored in a computer program product and loaded into computer system 800 using removable storage drive 814, hard drive 812 or communications interface 824. The control logic (software), when executed by the processor 804, causes the processor 804 to perform the functions of the invention as described herein.

In another aspect, the invention is implemented primarily in hardware using, for example, hardware components such as application specific integrated circuits (ASICs). Implementation of the hardware state machine so as to perform the functions described herein will be apparent to persons skilled in the relevant art(s).

In yet another aspect, the invention is implemented using a combination of both hardware and software.

### CONCLUSION

While various aspects of the present invention have been described above, it should be understood that they have been presented by way of example and not limitation. It will be apparent to persons skilled in the relevant art(s) that various changes in form and detail can be made therein without departing from the spirit and scope of the present invention. Thus, the present invention should not be limited by any of the above described exemplary aspects.

In addition, it should be understood that the figures in the attachments, which highlight the structure, methodology, functionality and advantages of the present invention, are presented for example purposes only. The present invention is sufficiently flexible and configurable, such that it may be implemented in ways other than that shown in the accompanying figures.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present invention in any way.

What is claimed is:

1. A computer-implemented method for facilitating a consumer acquisition marketplace accessible by a plurality of advertisers, the method comprising the steps of:
(a) receiving, from a plurality of advertisers, advertiser data in order to allow each of the plurality of advertisers to exchange advertising opportunities;
(b) storing the advertiser data in a database;
(c) receiving, from the plurality of advertisers, consumer behavior data, the consumer behavior data comprising:
advertiser clickstreams;
online transactions made by consumers;
offline transactions made by consumers;
merchandise data; and
customer data;
(d) analyzing the consumer behavior data and the stored advertiser data;
(e) generating a valuation score indicating the value of at least one consumer to at least one advertiser, wherein the valuation score is at least partially based on the analysis of step (d) and at least partially based on the stored advertiser data; and
(f) facilitating the exchange of an advertising opportunity between the at least one advertiser and a second advertiser from the plurality of advertisers, wherein the advertising opportunity is configured to present the at least one consumer with an advertisement and the exchange is at least partially based on the valuation score of the at least one consumer.

2. A computer-implemented method for facilitating the optimization of advertising purchase bids in an advertising auction, the method comprising the steps of:
(a) receiving, from a service provider, the value of an advertising opportunity to a first advertiser; wherein the advertising opportunity value is at least partially based on the present value of the advertising opportunity to the first advertiser;
(b) submitting a bid on the advertising opportunity; wherein the bid is below the first advertiser value and high enough to acquire the advertising opportunity; and
(c) facilitating, via a service provider computing device, the transfer of the acquired advertising opportunity to the first advertiser.

3. A computer-implemented method for facilitating the determination of advertising opportunity service provider compensation, wherein compensation is provided based on a timeframe, the method comprising:
(a) receiving advertisement information indicating a product being advertised in an advertisement;
(b) receiving a control population transaction activity level, the control population transaction activity level comprising control population purchasing data indicating the frequency of advertised product purchases per unit time by the control population during a timeframe; wherein the advertising opportunity service provider has not presented the control population with the advertisement during the timeframe;
(c) receiving a test population transaction activity level, the test population transaction activity level comprising test population purchasing data indicating the frequency of advertised product purchases per unit time by the test population during the timeframe; wherein the advertising opportunity service provider has presented the test population with the advertisement during the timeframe;
(d) determining a time period over which the test population purchased more products than the control population by comparing the control population transaction activity level to the test population activity level; and
(e) compensating the advertising opportunity service provider for at least one purchase occurring during the time period determined in step (d).

4. A computer-implemented method for facilitating a consumer acquisition marketplace accessible by a plurality of advertisers, the method comprising the steps of:
(a) receiving, from a plurality of advertisers, advertiser data, the advertiser data comprising: advertiser product offerings; and advertiser target markets;
(b) storing the advertiser data in a database;
(c) receiving, from the plurality of advertisers, consumer behavior data, the consumer behavior data comprising: advertiser clickstreams; online transactions made by consumers; offline transactions made by consumers; merchandise data; and customer data;
(d) analyzing the consumer behavior data and the stored advertiser data;
(e) generating a first valuation score indicating the value of a consumer to a first advertiser from the plurality of advertisers, wherein the valuation score is at least partially based on the analysis of step (d) and at least partially based on the stored advertiser data;
(f) generating a second valuation score indicating the value of the consumer to a second advertiser from the plurality of advertisers, wherein the valuation score is at least partially based on the analysis of step (d) and at least partially based on the stored advertiser data;
(g) presenting the consumer with the first valuation score and the identity of the first advertiser; and
(h) presenting the consumer with the second valuation score and the identity of the second advertiser.
